(19) United States
(12) Patent Application Publication
(10) Pub. No.: US 2026/0192427 A1
(43) Pub. Date: Jul. 9, 2026

(54) NAIL GUN

(71) Applicant: NANJING CHERVON INDUSTRY CO., LTD., Nanjing (CN)

(72) Inventors: Bin YANG, Nanjing (CN); Jingdong HAO, Nanjing (CN); Xiangqing FU, Nanjing (CN)

(73) Assignee: NANJING CHERVON INDUSTRY CO., LTD., Nanjing (CN)

(21) Appl. No.: 19/553,489

(22) Filed: Mar. 2, 2026

Related U.S. Application Data
(63) Continuation of application No. PCT/CN2024/120468, filed on Sep. 23, 2024.

(30) Foreign Application Priority Data
Nov. 3, 2023 (CN) 202311473926.8
Sep. 13, 2024 (CN) 202411289393.2
Sep. 13, 2024 (CN) 202411290684.3
Sep. 13, 2024 (CN) 202422247129.4
Sep. 13, 2024 (CN) 202422249680.2

(51) Int. Cl. B25C 1/04; B25C 1/06

(52) U.S. Cl. CPC B25C 1/047; B25C 1/06

(57) ABSTRACT

Provided is a nail gun, including: a power assembly including at least a motor and a transmission assembly; a firing assembly including at least a cylinder assembly and a striker assembly; and a housing assembly including at least a first housing for a user to grip and a second housing for accommodating at least part of the firing assembly; where, at least part of the power assembly is located inside the first housing; and a distance D7 between a center of gravity of the nail gun and a central plane defined by the first housing along a front-rear direction and a vertical direction is less than or equal to 5 mm.

### RELATED APPLICATION INFORMATION

This application is a continuation of International Application Number PCT/CN2024/120468, filed on Sep. 23, 2024 through which this application also claims the benefit under 35 U.S.C. § 119(a) of Chinese Patent Application No. CN 202422249680.2, filed on Sep. 13, 2024, Chinese Patent Application No. CN 202411290684.3, filed on Sep. 13, 2024, Chinese Patent Application No. CN 202422247129.4, filed on Sep. 13, 2024, Chinese Patent Application No. CN 202411289393.2, filed on Sep. 13, 2024, and Chinese Patent Application No. CN 202311473926.8, filed on Nov. 3, 2023, which application are incorporated herein by reference in their entireties.

### TECHNICAL FIELD

The present disclosure relates to the technical field of electric power tools, and in particular to a nail gun.

### BACKGROUND

As a nailing tool, nail guns are used in various scenarios such as home decoration and construction sites. In practical applications, the requirements for nail guns extend beyond the quality and effectiveness of nailing to encompass operability or user comfort during handling.

This part provides background information related to the present disclosure, and the background information is not necessarily the existing art.

### SUMMARY

An object of the present application is to solve or at least alleviate part or all of the preceding problems. In view of this, an objective of the present disclosure is to provide a nail gun that offers a more comfortable handling feel and improved operability.

The present disclosure adopts the following technical solutions:

A nail gun includes: a power assembly including at least a motor and a transmission assembly; a firing assembly including at least a cylinder assembly and a striker assembly; and a housing assembly including at least a first housing for a user to grip and a second housing for accommodating at least part of the firing assembly; where, at least part of the power assembly is located inside the first housing and/or the second housing; and a distance D7 between a center of gravity of the nail gun and a central plane defined by the first housing along a front-rear direction and a vertical direction is less than or equal to 5 mm.

In an embodiment, the center of gravity of the nail gun is located at a left side of the central plane.

In an embodiment, the center of gravity of the nail gun is located at a right side of the central plane.

In an embodiment, the nail gun further includes: a drive assembly including at least a drive wheel rotatable in a forward direction to drive the striker assembly; and a transmission assembly disposed between the transmission assembly and the drive assembly to transmit power to the drive assembly; where, the transmission assembly includes at least a flexible transmission structure.

In an embodiment, the drive assembly further includes a one-way clutch structure disposed on a rear end of the drive wheel; and the one-way clutch structure is at least configured to prevent the drive wheel from rotating in a direction opposite to the forward direction.

In an embodiment, the transmission assembly further includes a first transmission wheel disposed on an output end of the transmission assembly; and a second transmission wheel disposed on a rear end of the drive wheel; and the flexible transmission structure includes one end sleeved on the first transmission wheel and another end sleeved on the second transmission wheel.

A nail gun includes: a power assembly including at least a motor and a transmission assembly; a firing assembly including at least a cylinder assembly and a striker assembly; and a housing assembly including at least a first housing for a user to grip and a second housing for accommodating at least part of the firing assembly; where, the striker assembly includes at least a striker and a piston disposed on a top end of the striker; and a distance D1 between the striker and a frontmost end of the second housing along a front-rear direction is less than or equal to 40 mm.

In an embodiment, the cylinder assembly includes at least an inner cylinder and an outer cylinder that is at least partially exposed outside; and a first center line of the inner cylinder is substantially parallel to a second center line of the outer cylinder along a vertical direction.

In an embodiment, along the front-rear direction, the first center line is located in front of the second center line.

In an embodiment, an outer surface of the outer cylinder is at least partially exposed outside the second housing.

In an embodiment, an outer surface of the outer cylinder is at least partially provided with a protective layer.

In an embodiment, the protective layer includes at least a polyurea coating.

A nail gun includes: a power assembly including at least a motor and a transmission assembly; a firing assembly including at least a cylinder assembly and a striker assembly; and a housing assembly including at least a first housing for a user to grip and a second housing for accommodating at least part of the firing assembly; where, the cylinder assembly includes at least an inner cylinder and an outer cylinder that is at least partially exposed outside; and an outer surface area of the outer cylinder exposed outside the second housing accounts for at least 20% of a total outer surface area of the outer cylinder.

A nail gun includes: a main body including: a power assembly including at least a motor and a transmission assembly; a firing assembly including at least a cylinder assembly and a striker assembly; and a housing assembly including at least a first housing for a user to grip and a second housing for accommodating at least part of the firing assembly; where, the nail gun further includes: a magazine assembly including at least a magazine for storing a nail; where, a distance D3 between a lowermost end of a grip portion of the first housing for the user to grip and an uppermost end of a frontmost end of a connection joint between the magazine assembly and the main body along a vertical direction is less than or equal to 60 mm.

In an embodiment, the nail gun further includes: a drive assembly including at least a drive wheel rotatable in a forward direction to drive the striker assembly; and a third center line of a wheel axle of the drive wheel is substantially parallel to a motor axis of the motor or a transmission assembly axis of the transmission assembly along a front-rear direction.

In an embodiment, a distance D2 between the third center line and the motor axis is less than or equal to 80 mm.

In an embodiment, the nail gun further includes: a trigger disposed below the first housing and at least partially located inside the first housing and/or the second housing; and along the vertical direction, a distance D4 between a lowermost end of the trigger and the uppermost end of the frontmost end of the connection joint between the magazine assembly and the main body is less than or equal to 50 mm.

In an embodiment, the nail gun further includes: a trigger switch configured to be triggered when the trigger is operated; and the trigger switch is at least partially disposed inside the second housing.

In an embodiment, the trigger switch is at least partially disposed inside the first housing.

In an embodiment, the trigger switch is at least partially disposed inside the trigger.

A nail gun includes: a power assembly including at least a motor and a transmission assembly; a firing assembly including at least a cylinder assembly and a striker assembly; and a housing assembly including at least a first housing for a user to grip and a second housing for accommodating at least part of the firing assembly; where, a diameter of the motor is less than 38 mm.

In an embodiment, an outer diameter of the transmission assembly is less than or equal to 38 mm.

In an embodiment, the diameter of the motor is less than or equal to 36 mm.

A nail gun includes: a power assembly including at least a motor and a transmission assembly; a firing assembly including at least a cylinder assembly and a striker assembly; and a housing assembly including at least a first housing for a user to grip and a second housing for accommodating at least part of the firing assembly; where, a weight of the nail gun is less than or equal to 2 kg.

In an embodiment, the cylinder assembly includes at least an inner cylinder and an outer cylinder that is at least partially exposed outside; and a first center line of the inner cylinder is substantially parallel to a second center line of the outer cylinder along a vertical direction.

In an embodiment, at least 20% of an outer surface of the outer cylinder is exposed outside the second housing.

In an embodiment, the power assembly is accommodated inside the first housing.

A nail gun includes: a power assembly including at least a motor and a transmission assembly; a firing assembly including at least a cylinder assembly and a striker assembly; and a housing assembly including at least a first housing for a user to grip and a second housing for accommodating at least part of the firing assembly; where, during the operation of the nail gun, a surface temperature of the first housing is less than or equal to 55° C.

In an embodiment, the power assembly is accommodated inside the first housing.

In an embodiment, the nail gun further includes: a heat dissipation assembly; and the heat dissipation assembly is at least partially disposed inside the first housing and/or the second housing, and is configured to dissipate heat for the power assembly.

In an embodiment, the heat dissipation assembly includes a heat-conducting member; and the heat-conducting member is configured to conduct at least part of the heat of the power assembly outwards.

In an embodiment, the heat-conducting member is at least connected between the motor and the cylinder assembly.

In an embodiment, the heat-conducting member is at least connected between the transmission assembly and the cylinder assembly.

In an embodiment, the heat-conducting member is at least connected between the motor and the second housing.

In an embodiment, the heat-conducting member is at least connected between the transmission assembly and the second housing.

In an embodiment, the heat-conducting member includes at least one of a phase-change heat-conducting member or a metal heat-conducting member.

In an embodiment, the heat dissipation assembly includes a cooling fan; and the cooling fan is connected to at least part of the power assembly.

A nail gun includes: a power assembly including at least a motor and a transmission assembly; a firing assembly including at least a cylinder assembly and a striker assembly; and a housing assembly including at least a first housing for a user to grip and a second housing for accommodating at least part of the firing assembly; where, at least part of the power assembly is located inside the first housing and/or the second housing; and a distance D9 between a center of gravity of the nail gun and a lowermost end of a grip portion of the first housing along a vertical direction is less than or equal to 20 mm.

In an embodiment, the center of gravity of the nail gun is located above the lowermost end of the grip portion of the first housing.

In an embodiment, the center of gravity of the nail gun is located below the lowermost end of the grip portion of the first housing.

A method for repairing a nail gun is further provided, where the nail gun includes: a power assembly including at least a motor and a transmission assembly; a firing assembly including at least a cylinder assembly and a striker assembly; and a housing assembly including at least a first housing for a user to grip and a second housing for accommodating at least part of the firing assembly; where, the cylinder assembly includes at least an inner cylinder and an outer cylinder covering an upper end opening of the inner cylinder; the method includes: exposing the upper end opening of the inner cylinder by removing the outer cylinder, and disassembling the striker assembly inside the inner cylinder through the upper end opening of the inner cylinder without removing the housing assembly.

In an embodiment, a cylinder diameter of the inner cylinder is smaller than a cylinder diameter of the outer cylinder; and in a projection plane perpendicular to a vertical direction, a projection of the outer cylinder fully covers a projection of the inner cylinder.

### BRIEF DESCRIPTION OF THE DRAWINGS

FIG. 1 is a schematic structural diagram of a nail gun in an embodiment;

FIG. 2 is a schematic structural diagram of the nail gun from another perspective in an embodiment;

FIG. 3 is a schematic structural diagram of the nail gun from another perspective with a center of gravity of the whole machine marked in an embodiment;

FIG. 4 is a cross-sectional view of the nail gun in an embodiment;

FIG. 5 is a structural diagram of the nail gun with part of a housing removed in an embodiment;

FIG. 6 is a structural diagram of an internal transmission system of the nail gun in an embodiment;

FIG. 7 is a schematic diagram of a position of a trigger switch in an embodiment;

FIG. 8 is a schematic diagram of a position of the trigger switch in an embodiment;

FIG. 9 is a schematic diagram of an arrangement of an operating mode selection module of the nail gun in an embodiment;

FIG. 10 is a schematic diagram of an arrangement of the operating mode selection module of the nail gun in an embodiment;

FIG. 11 is a schematic structural diagram of an arrangement position of a power assembly in an embodiment;

FIG. 12 is a schematic structural diagram of an arrangement position of the power assembly in an embodiment;

FIG. 13 is a schematic structural diagram of the nail gun from another perspective with the center of gravity of the whole machine marked in an embodiment;

FIG. 14 is a cross-sectional view of the nail gun in an embodiment;

FIG. 15 is a cross-sectional view of the nail gun in an embodiment; and

FIG. 16 is an exploded view of a partial structure of the nail gun in an embodiment.

### DETAILED DESCRIPTION OF THE EMBODIMENTS

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate member and the two members or assemblies are connected by the at least one intermediate member. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

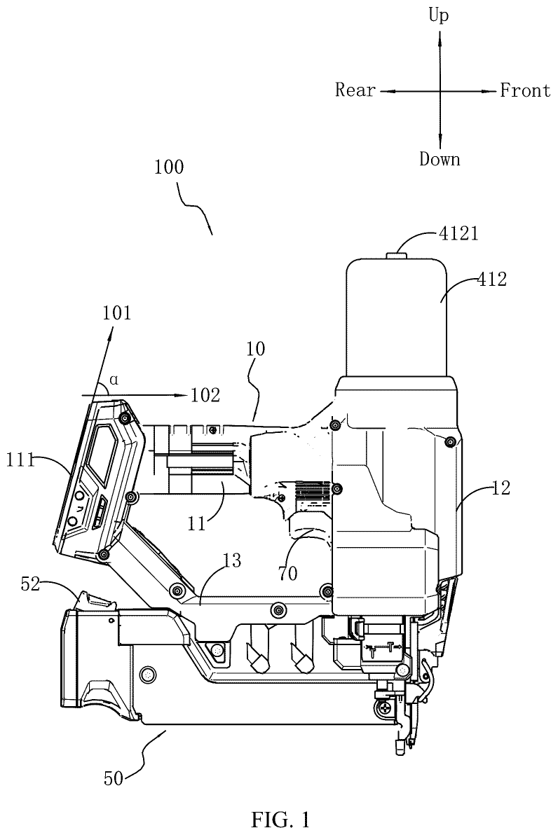

Terms such as upper, lower, left, right, front, and rear used herein can refer to the orientations shown in FIGS. 1 to 6.

As shown in FIGS. 1 to 6, nail gun 100 includes: housing assembly 10, power assembly 20, drive assembly 30, firing assembly 40, and magazine assembly 50. The power assembly 20 serves as a power source for driving the nail gun 100 to drive nails. The power generated by the power assembly 20 is transmitted to the drive assembly 30. The drive assembly 30 drives the firing assembly 40 to perform a nailing action. The magazine assembly 50 is at least configured to store nails.

In this embodiment, the housing assembly 10 at least includes or forms first housing 11 for a user to grip, i.e., a grip portion, and second housing 12 for accommodating at least part of the firing assembly 40. The first housing 11 extends substantially along a front-rear direction, and the second housing 12 extends substantially along a vertical direction. That is, the first housing 11 and the second housing 12 are substantially perpendicular. This embodiment does not make a clear distinction between the connection joint between the first housing 11 and the second housing 12. Taking the orientations shown in FIGS. 1 to 6 as an example, the second housing 12 is disposed on a front end of the nail gun 100. When the user holds the grip portion, i.e., the first housing 11, to drive nails, the second housing 12 is substantially perpendicular to a horizontal plane.

As shown in FIGS. 1 to 5, the first housing 11 is provided with battery coupling portion 111, and the battery coupling portion 111 is formed at a rear end of the first housing 11. Angle α between mounting direction 101 of a battery pack and extension direction 102 of the first housing 11 is less than or equal to 90°. This embodiment does not limit the type of the battery pack applicable to the nail gun 100. For example, it can be a lithium battery pack, a sodium-ion battery pack, or a lithium iron phosphate battery pack.

The power assembly 20 at least includes motor 21 and transmission assembly 22. The motor 21 is rotatable to generate power, thereby driving the drive assembly 30 to drive the firing assembly 40 to drive nails. In an embodiment, the motor 21 can be a brushed motor, a brushless motor, a sensor motor, or a sensorless motor. The transmission assembly 22 can be a transmission gearbox or a set of transmission gears, etc. The transmission assembly 22 is disposed on a front end of the motor 21 and is internally provided with a plurality of gears (not shown in the figure) with a certain transmission ratio, which can change the rotational speed transmitted by the motor 21 to the drive assembly 30. In this embodiment, at least part of the transmission assembly 20 is disposed inside the first housing 11. Exemplarily, both the motor 21 and the transmission assembly 22 are disposed inside the first housing 11. Alternatively, the motor 21 is disposed inside the first housing 11, and the transmission assembly 22 is partially disposed inside the first housing 11 and partially disposed on the connection joint of the first housing 11 and the second housing 12.

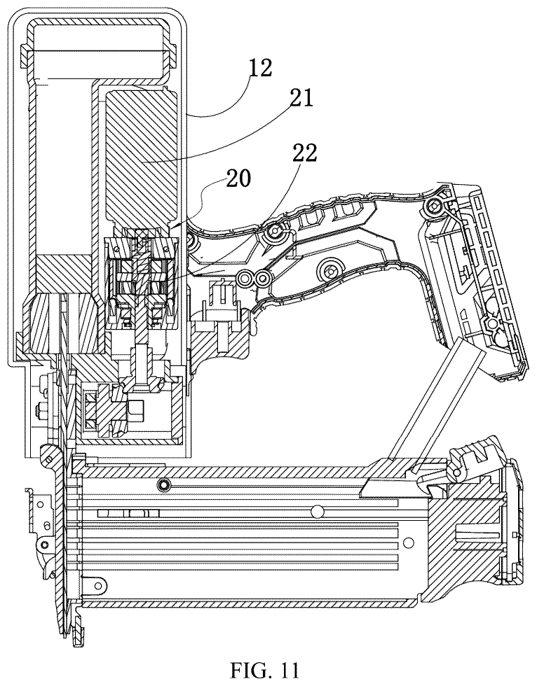

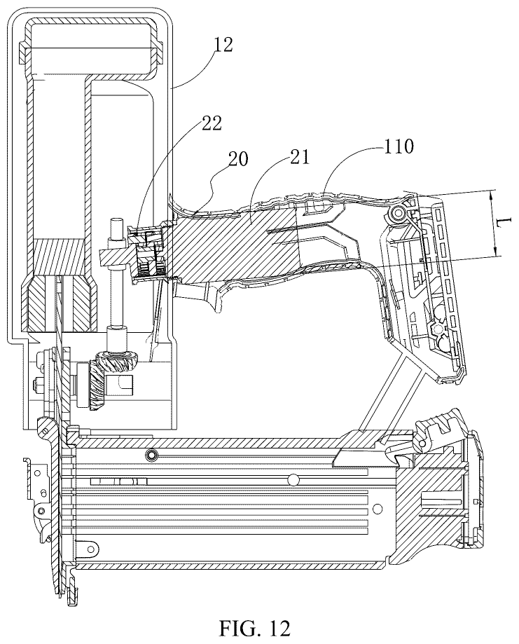

In other embodiments, referring to FIG. 11, the power assembly 20 can also be disposed inside the second housing 12. As shown in FIG. 12, the motor 21 is disposed inside the first housing 11, or at least disposed inside the grip portion 110, and the transmission assembly 22 is disposed inside the second housing 12.

As shown in FIG. 12, diameter L of the motor 21 is less than 38 mm, or less than or equal to 36 mm, or less than or equal to 35 mm, or less than or equal to 33 mm, or less than or equal to 30 mm. An outer diameter of the transmission assembly 22 is less than or equal to 35 mm, or less than or equal to 33 mm, or less than or equal to 30 mm. To ensure the small outer diameter of the transmission assembly 22, an outer gear ring of the transmission assembly 22 can also serve as a housing of the transmission assembly 22. Alternatively, no shaft lock affecting the diameter of the transmission assembly 22 is disposed inside the transmission assembly 22. Thus, the outer diameter of the first housing 11 is small, facilitating grip of the user.

It can be understood that the power assembly 20 will generate a lot of heat during operation. To dissipate heat for the motor 21 or the transmission assembly 22, a cooling fan can be disposed on the front end of the motor 21, or at a rear end of the transmission assembly 22, or between the motor 21 and the transmission assembly 22. Alternatively, a phase change material can be disposed, connected or sprayed on at least part of the power assembly 20. The phase change of the phase change material is utilized to take away part of the heat, so as to at least achieve the purpose of reducing the surface temperature of the first housing or reducing the surface temperature of the grip portion 110. For example, the transmission assembly 22 and/or the motor 21 is externally sprayed or wrapped with a phase change material. In some embodiments, a phase-change heat-conducting member can be connected between the power assembly 20 and the cylinder assembly 41. The phase change characteristic of the phase-change heat-conducting member is utilized to transfer the heat of the motor 21 and/or the transmission assembly 22 to inner cylinder 411 and/or outer cylinder 412. In some embodiments, a metal heat-conducting member can be connected between the motor 21 and the cylinder assembly 41, such as a copper sheet, to transfer the heat generated by the rotation of the motor 21 to the inner cylinder 411 and/or the outer cylinder 412 for dissipation. Alternatively, a metal heat-conducting member is connected between the transmission assembly 22 and the cylinder assembly 41. In other embodiments, metal heat-conducting members and/or phase-change heat-conducting members can be respectively connected between the motor 21 and the cylinder assembly 41 and between the transmission assembly 22 and the cylinder assembly 41.

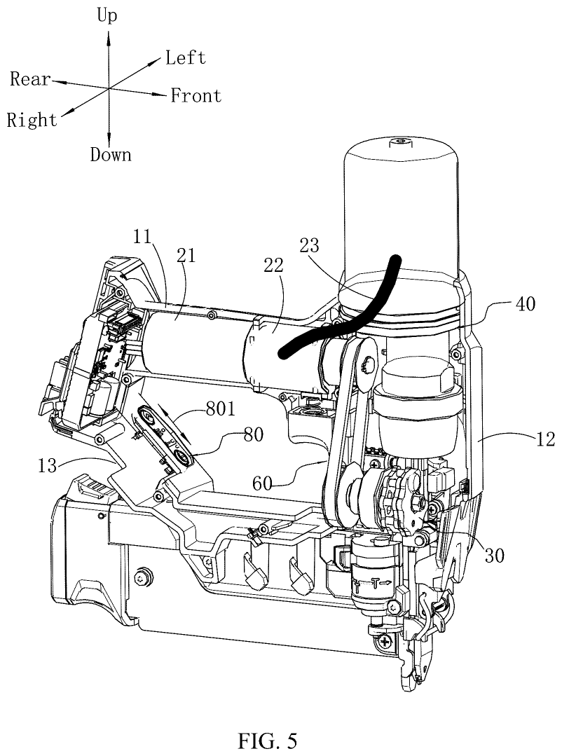

As shown in FIG. 5, heat-conducting member 23 is connected between the transmission assembly 22 and the cylinder assembly 41, which can be, for example, a metal heat-conducting member or a phase-change heat-conducting member. In some embodiments, the heat-conducting member 23 includes at least one end connected to a surface of the motor 21 or a surface of the transmission assembly 22 and another end connected to a surface of the inner cylinder 411, or connected to a surface of the outer cylinder 412, or connected to the second housing 12, or connected to a bracket inside the second housing 11, or connected to a metal part of the nail gun 100 far away from the power assembly 20, such as a nail rail for guiding out the nails. Of course, other connection methods can also be employed to connect the heat-conducting member 23, which will not be listed one by one herein.

In this embodiment, the cooling fan, the phase-change heat-conducting member or the metal heat-conducting member can be referred to as a heat dissipation assembly for dissipating heat for the power assembly 20. It can be understood that at least one of the heat dissipation assemblies can be employed to dissipate heat for the power assembly 20, and other types of heat dissipation assemblies can also be employed to dissipate heat for the power assembly 20 on the premise of basically not affecting the size of the grip portion 110, which will not be listed herein.

In this embodiment, a surface temperature of the first housing 11 is less than or equal to 50° C., or a surface temperature of at least the grip portion 110 is less than or equal to 50° C. In other embodiments, the surface temperature of the first housing 11 or at least the grip portion 110 is less than or equal to 50° C., or less than or equal to 45° C., or less than or equal to 40° C., etc.

The power generated by the power assembly 20 is transmitted to the drive assembly 30, such that the drive assembly 30 can drive the firing assembly 40 to drive nails. The drive assembly 30 at least includes drive wheel 31. The drive wheel 31 is consistent with that in the related art, which will not be described in detail herein.

The firing assembly 40 at least includes cylinder assembly 41 and striker assembly 42. The striker assembly 42 is at least partially located inside the cylinder assembly 41. In this embodiment, the cylinder assembly 41 at least includes the inner cylinder 411 and the outer cylinder 412.

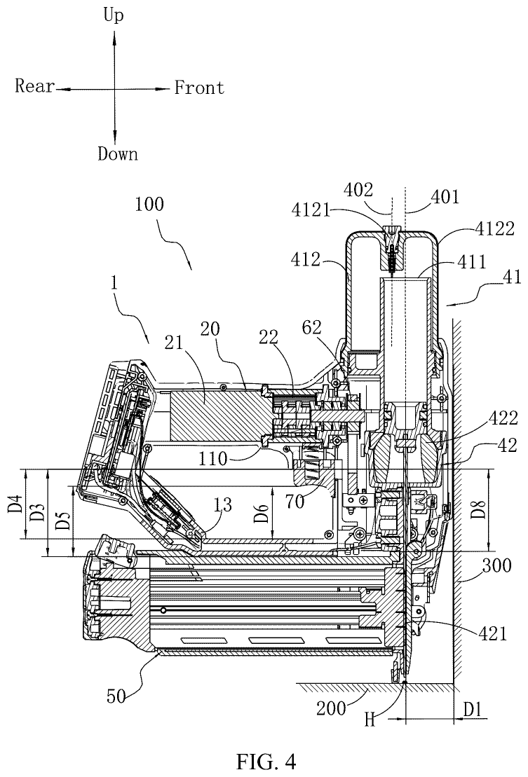

In an embodiment, as shown in FIGS. 4 to 12, the inner cylinder 411 is at least partially nested inside the outer cylinder 412, for example, at least an upper end of the inner cylinder 411 is disposed inside the outer cylinder 412. A top end or an upper end of the outer cylinder 412 is provided with inflation nozzle 4121 for pre-charging a gas into the cylinder assembly 41. The pre-charged gas stores large kinetic energy in a compressed state and can push the striker assembly 42 to drive out nails. In this embodiment, unless otherwise specified, during the operation of the nail gun 100, the inflation nozzle 4121 is not open. The cylinder assembly 41 has no gas exchange with the outside environment, such that the pre-charged gas in the cylinder assembly 41 can passively do work to generate kinetic energy for pushing the striker assembly 42. In an embodiment, the outer cylinder 412 can further be provided with a gas inlet nozzle and a gas outlet nozzle. In this case, there is no need to pre-charge the gas, and the gas can be charged during the operation of the nail gun 100. In this embodiment, the striker assembly 42 at least includes striker 421 and piston 422 disposed on a top end of the striker 421, and the piston 422 is disposed inside the inner cylinder 411.

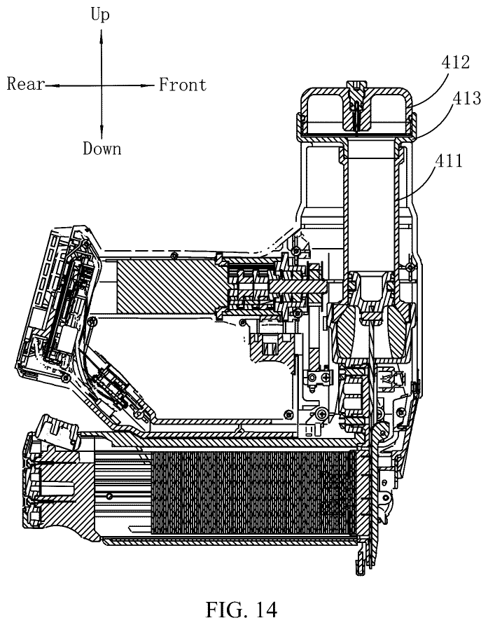

In an embodiment, as shown in FIG. 14, the inner cylinder 411 is at least partially disposed inside the second housing 12, the outer cylinder 412 is at least partially exposed outside the second housing 12, and at least the inner cylinder 411 is not disposed inside the outer cylinder 412.

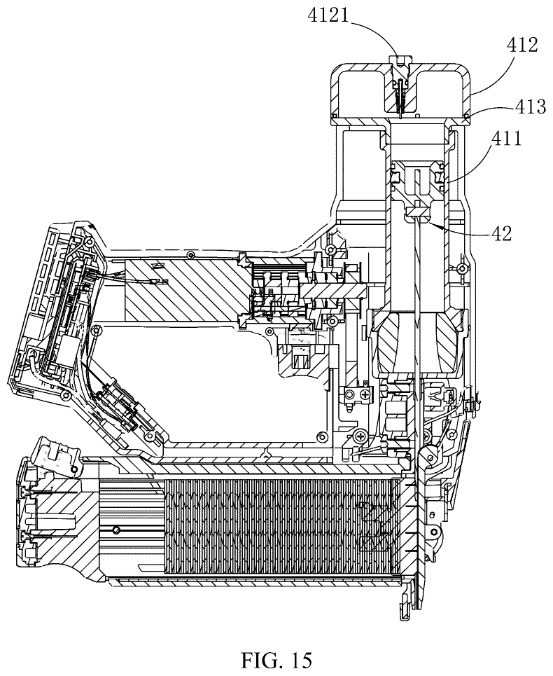

In an embodiment, referring to FIGS. 14 and 15, the inner cylinder 411 is communicated with the outer cylinder 412 through intermediate member 413. The intermediate member 413 is at least partially disposed inside the inner cylinder 411. The outer cylinder 412 is completely exposed outside the second housing 12. Projections of the inner cylinder 411 and the outer cylinder 412 in a projection plane perpendicular to a left-right direction do not overlap. In this embodiment, the intermediate member 413 can be integrally formed with the inner cylinder 411, or can be detachably disposed on the inner cylinder 411.

In this embodiment, an upper end opening of the inner cylinder 411 is disposed opposite to and attached to a lower end opening of the outer cylinder 412, which can at least ensure that the gas entering from the inflation nozzle 4121 of the outer cylinder 412 can enter the inner cylinder 411. In addition, the projections of the inner cylinder 411 and the outer cylinder 412 on the projection plane perpendicular to the left-right direction do not overlap, such that the gas charged into the outer cylinder 412 can quickly enter the inner cylinder 411.

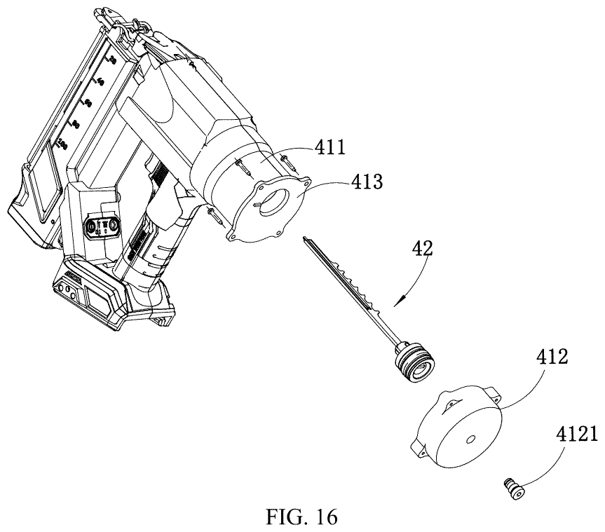

In this embodiment, the outer cylinder 412 or its outer surface is completely exposed outside the second housing 12. Thus, after a fastener between the outer cylinder 412 and the inner cylinder 411 or a fastener between the outer cylinder 412 and the intermediate member 413 is removed, the outer cylinder 412 can be directly removed from the nail gun, thereby exposing the opening of the inner cylinder 411 and the striker assembly 42 disposed inside the inner cylinder 411, as shown in FIG. 16. When replacement is needed due to damage of the striker 421 or other problems, the outer cylinder 412 can be directly removed from the nail gun without disassembling the housing assembly 10 to expose the striker assembly 42 inside the inner cylinder 411, and then the striker assembly 42 can be directly pulled out from the inner cylinder 411 upward for quick replacement. In this embodiment, the fastener can be a screw.

In some embodiments, the housing assembly 10 can further include an outer cylinder cover for partially or completely wrapping the outer surface of the exposed outer cylinder 412, especially a position that is easily damaged, such as the top end of the outer cylinder 412. The outer cylinder cover can be fixed to the outer cylinder 412 or the housing assembly 10 through a plurality of fasteners. The outer cylinder 412 can be exposed by removing the outer cylinder cover, and then the outer cylinder 412 can be removed to expose the opening of the inner cylinder 411 and the striker assembly 42 therein.

It should be noted that before the outer cylinder 412 is removed, the gas pressure inside the cylinder assembly 41 can be reduced by an algorithm, or the gas inside the cylinder assembly 41 can be released by opening the inflation nozzle 4121 of the outer cylinder 412 to reduce the gas pressure inside the cylinder assembly 41. In this way, the safety can be ensured when the outer cylinder 412 is removed.

In an embodiment, the outer cylinder 412 can be at least partially disposed inside the inner cylinder 411.

The terms “inner” and “outer” in this embodiment are only used to distinguish and name the cylinders. The inner cylinder 411 can also be called a drive cylinder, and the outer cylinder 412 can also be called a storage cylinder.

The nailing process of the nail gun 100 in one nailing cycle will be described below in conjunction with each component in the firing assembly 40. After the nail gun 100 is shut down, the motor 21 stops outputting power. Finally, the striker assembly 42 or the striker 421 rests at an initial position, and the pre-charged gas in the cylinder assembly 41 is in a compressed state. After the nail gun 100 is energized and the motor 21 is activated, the motor 21 outputs power. The striker assembly 42 is released to obtain a large acceleration instantaneously, which makes it move from the initial position to a firing position and drive out the nails stored in the magazine assembly 50. After driving out the nails, the striker assembly 42 returns from the firing position to the initial position and rests under the drive of the motor 21. In this process, the striker assembly 42 or the piston 422 can continuously compress the gas in the cylinder assembly 41, or continuously compress the gas in the inner cylinder 411. Since the inner cylinder 411 is communicated with the outer cylinder 412, the gas in the outer cylinder 412 is also compressed. The above process, starting from the energization of the motor 21, i.e., the activation of the nail gun 100 and ending with the return of the striker assembly 42 to the initial position or a position adjacent to the initial position, i.e., a shutdown position after nail driving, is defined as one nailing cycle. It should be noted that the initial position refers to a position where the striker assembly 42 rests after the nail gun 100 is shut down, and thus may also be referred to as the shutdown position. A farthest position that the striker assembly 42 can move upward can be called a top dead center, and the farthest position that the striker assembly can move downward is called a bottom dead center. The firing position and the bottom dead center can be the same position, and the initial position is close to the top dead center from bottom to top but does not serve as the top dead center. That is, the distance between the initial position and the top dead center is greater than zero.

In this embodiment, the inner cylinder 411 and the outer cylinder 412 are basically cylindrical structures. As shown in FIG. 4, along the vertical direction, first center line 401 of the inner cylinder 411 is substantially parallel to second center line 402 of the outer cylinder 412, and the first center line 401 is located in front of the second center line 402. That is, the first center line 401 and the second center line 402 do not coincide. The inner cylinder 411 is offset inside the outer cylinder 412, and the inner cylinder 411 is disposed close to a front end of the outer cylinder 412. Thus, the first center line 401 is closer to a frontmost end of the second housing 12. In this embodiment, the piston 422 is basically a cylindrical structure and is disposed inside the inner cylinder 411. The striker 421 is basically disposed on a center point of the piston 422. Therefore, the first center line 401 is basically a center line of the striker 421. It can be understood that when the nail gun 100 drives nails, an intersection point of the center line of the striker 421 and workpiece 200 is basically a nail exit position. That is, the mounting position of the inner cylinder 411 inside the outer cylinder 412 is related to the nail exit position of the nail gun 100. When there is a wall or other obstacles blocking in front, a more forward nail exit position of the nail gun 100 leads to a smaller edge distance of the nail gun 100 for nailing and a better nailing effect of the nail gun at a corner or a turning point. The edge distance can be understood as a distance between the nailing position and the front obstacle (e.g., a wall surface).

Since the frontmost end of the second housing 12 can be understood as a frontmost end of the nail gun 100 when the nail gun 100 drives nails, even if there is an obstacle at the front end of the nail gun 100, at least the frontmost end of the second housing 12 needs to contact the obstacle for the nail gun 100 to drive nails. Referring to FIG. 4, assuming that there is obstacle 300 blocking the front of the nail gun 100, the nail gun 100 can drive nails at position H farthest forward. That is, the nailing position H is basically the intersection point of the first center line 401 and the workpiece 200. Thus, distance D1 between the first center line 401 and the frontmost end of the second housing 12 can be understood as the edge distance. In other embodiments, the distance from a position close to or adjacent to the first center line 401 to the frontmost end of the second housing 12 can also be understood as the edge distance. Since the inner cylinder 411 is offset forward inside the outer cylinder 412, the edge distance of the nail gun 100 for nailing is shortened to a certain extent, thereby ensuring the nailing effect of the nail gun at special positions.

In this embodiment, the distance D1 between the first center line 401 and the frontmost end of the second housing 12, or the edge distance, is less than or equal to 40 mm. Since the first center line 401 is basically the center line of the striker 421, it can also be understood that the distance between the striker 421 and the frontmost end of the second housing 12 is less than or equal to 40 mm. In other embodiments, the distance D1 can be any value less than or equal to 35 mm, or any value less than or equal to 30 mm.

In this embodiment, the outer surface of the outer cylinder 412 is at least partially exposed outside the second housing 12; that is, the outer cylinder 412 is not entirely inside the second housing 12. Referring to FIGS. 4 and 5, most of the second cylinder 412 is exposed outside, thereby reducing the coverage range of the housing assembly 10 to a certain extent, reducing the weight of the nail gun 100, and also reducing the edge distance to a certain extent. This ensures a better nailing effect of the nailing operation at corners or turning points.

In this embodiment, an outer surface area of the outer cylinder 412 exposed outside the second housing 12 accounts for at least 20% of a total outer surface area of the outer cylinder 412, or at least 30%, or 40%, or 50%, or 60%, or 70% of the total outer surface area of the outer cylinder 412. In an embodiment, at least the front end of the outer cylinder 412 is exposed outside the second housing 12. That is, no housing is disposed on the front end of the outer cylinder 412, so as to avoid the housing outside the outer cylinder 412 increasing the edge distance of the nail gun 100. Most of the outer cylinder 412 is exposed outside the second housing 12, which largely eliminates the need for an outer housing of the cylinder, at least reduces the consumption of the second housing 12, and thus reduces the overall weight of the nail gun 100.

In this embodiment, to protect the exposed outer cylinder 412, protective layer 4122 is disposed at least on the exposed outer surface of the outer cylinder 412. Exemplarily, the protective layer 4122 can include one or more layers of polyurea coating. In other embodiments, a metal protective layer, a plastic protective layer, or a protective layer with elasticity or buffering property can also be used, which will not be listed one by one herein.

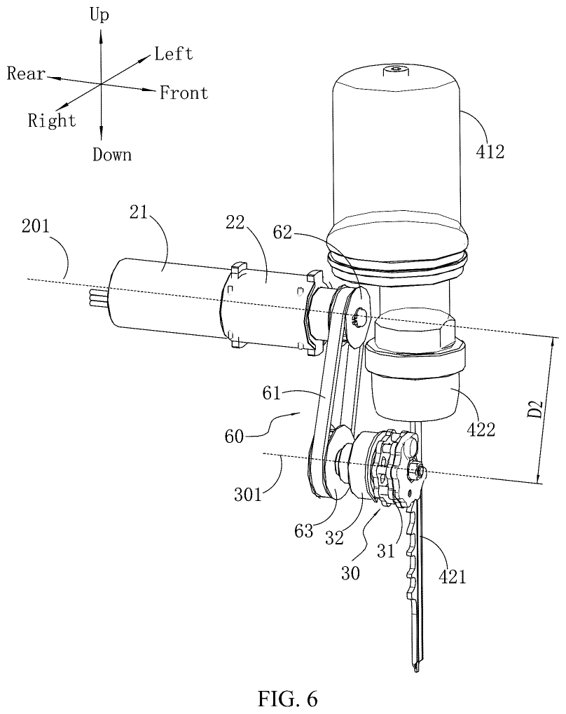

In the vertical direction, the power assembly 20 and the drive assembly 30 are not on the same horizontal plane. In this embodiment, along the front-rear direction, third center line 301 of a wheel axle of the drive wheel 31 is substantially parallel to and not coincident with motor axis 201 of the motor 21. In an embodiment, as shown in FIG. 6, distance D2 between the third center line 301 and the motor axis 201 is less than or equal to 80 mm. In other embodiments, D2 is less than or equal to 75 mm, or less than or equal to 70 mm, or less than or equal to 65 mm. It can be understood that the motor axis 201 is basically coincident with a central axis of the transmission assembly 22. Therefore, in some implementations, it can also be understood that the third center line 301 is substantially parallel to the central axis of the transmission assembly 22, and the distance between them is basically the same as D2.

In this embodiment, transmission assembly 60 is further disposed between the power assembly 20 and the drive assembly 30. Specifically, the transmission assembly 60 is disposed between the transmission assembly 22 and the drive wheel 31 to transmit power to the drive wheel 31. In this embodiment, the transmission assembly 60 at least includes flexible transmission member 61, first transmission wheel 62 connected or coupled to an output shaft or output end of the transmission assembly 22, and second transmission wheel 63 connected or coupled to an output end of the drive assembly 30. The flexible transmission member 61 can be a synchronous belt, a chain or a multi-wedge belt. To prevent the striker 421 from sliding down from the initial position after the nail gun 100 is shut down, the drive assembly 30 further includes one-way clutch structure 32 disposed on a rear end of the drive wheel 31. The one-way clutch structure 32 can prevent the drive wheel 31 from being driven to rotate in a reverse direction by the striker 421, thereby preventing the striker 421 from accidentally falling from the initial position when not nailing. In the present disclosure, it is defined that when the drive assembly 30 or the drive wheel 31 rotates in a forward direction, it can drive the striker assembly 42 to drive nails, and the direction opposite to the forward direction is defined as the reverse direction. For example, if the drive wheel 31 rotates counterclockwise when the nail gun 100 operates normally, the one-way clutch structure 32 also rotates counterclockwise when the nail gun 100 operates normally, but the one-way clutch structure 32 can prevent the drive wheel 31 from rotating clockwise after the nail gun 100 is shut down. The operating principle of the one-way clutch structure 32 in the present disclosure is basically the same as that in the related art, which will not be described in detail herein. In other embodiments, the one-way clutch structure 32 can also be disposed on other positions, such as at a front end of the drive wheel 31. In an embodiment, the one-way clutch structure 32 can be a one-way bearing.

In other embodiments, a shaft lock can also be disposed inside the transmission assembly 22, and a radial dimension of the shaft lock is not greater than the outer diameter of the transmission assembly 22. The shaft lock is also configured to prevent the drive wheel 31 from rotating in the reverse direction after the nail gun 100 is shut down.

Referring to FIG. 6, in the entire transmission system of the nail gun 100, after the motor 21 is energized, it rotates and drives the transmission assembly 22 to rotate. The rotational speed of the output shaft of the transmission assembly 22 is different from the rotational speed of the motor 21. The rotation of the transmission assembly 22 drives the first transmission wheel 62 to rotate. The first transmission wheel 62 drives the second transmission wheel 63 to rotate through the flexible transmission member 61. Then the second transmission wheel 63 drives the one-way clutch structure 32 and the drive wheel 31 to rotate. The rotation of the drive wheel 31 can drive the striker 421 to drive nails and rest at the initial position within one nailing cycle.

In this embodiment, the transmission assembly 60 with the flexible transmission member 61 is employed to realize the transmission from the power assembly 20 to the drive assembly 30. This reduces the overall weight, reduces the number of parts inside the machine body, simplifies mounting, and greatly reduces the vibration transmitted by the cylinder assembly 41 to the transmission assembly 22.

In other embodiments, a gear set can also be employed to realize the power transmission from the transmission assembly 22 to the drive wheel 31, and the detailed structure of the gear set will not be introduced herein.

In this embodiment, the magazine assembly 50 is disposed on a lowermost end of the nail gun 100, substantially parallel to the first housing 11. That is, the magazine assembly 50 is basically disposed along the front-rear direction. In an optional implementation, the magazine assembly 50 is further provided with window 51 for the user to observe the remaining nails. The window 51 includes one or more gaps on the magazine assembly 50. On the one hand, it allows the user to check the remaining number of nails. On the other hand, it allows the user to perform simple maintenance on the magazine assembly 50 without disassembling the magazine assembly 50. In this embodiment, the magazine assembly 50 further includes magazine switch 52 for the user to disassemble the magazine. In other embodiments, the magazine assembly 50 can form an angle less than 90° with the first housing 11 along the front-rear direction. That is, the magazine assembly 50 is not parallel to the first housing 11 along the front-rear direction.

In this embodiment, as shown in FIG. 4, along the vertical direction, distance D3 between a lowermost end of the first housing 11 and an uppermost end of the magazine assembly 50 is less than or equal to 60 mm, such as 60 mm, or 58 mm, or 57 mm, or 55 mm, or 50 mm. The power assembly 20 is disposed inside the first housing 11, such that the first housing 11, i.e., the grip portion 110, is closer to the lower end of the whole machine, i.e., closer to the magazine assembly 50, which further lowers the center of gravity of the whole machine and makes the whole machine more operable. In addition, by disposing the power assembly 20 inside the first housing 11, the housing assembly required for separately placing the power assembly 20 is reduced, thereby further reducing the weight of the whole machine.

In an embodiment, the housing assembly 10 further includes reinforced housing 13. The reinforced housing 13 further strengthens the connection between the first housing 11 and the second housing 12, thereby enhancing the structural strength of the whole machine. In an embodiment, the reinforced housing 13 can be at least partially connected to or disposed on the magazine assembly 50. Along the vertical direction, distance D4 between a lowermost end of the grip portion 110 of the first housing 11 for the user to grip and an uppermost end of the reinforced housing 13 is less than or equal to 50 mm, or less than or equal to 40 mm, or less than or equal to 35 mm. The grip portion 110 at least does not include the battery coupling portion 111. Alternatively, a part of the first housing 11 with the extension direction basically along the front-rear direction is defined as the grip portion 110.

In other embodiments, the reinforced housing 13 may not be provided to further reduce the influence of the housing assembly 10 on the weight of the whole machine. In some embodiments, an elastic member or a connecting member with shock absorption effect can be connected between the battery coupling portion 111 and the magazine assembly 50.

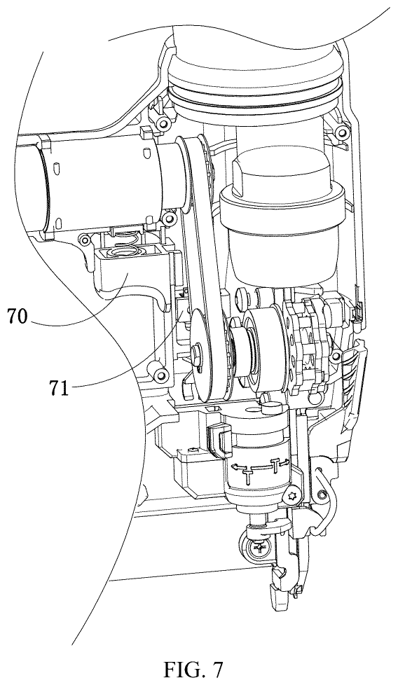

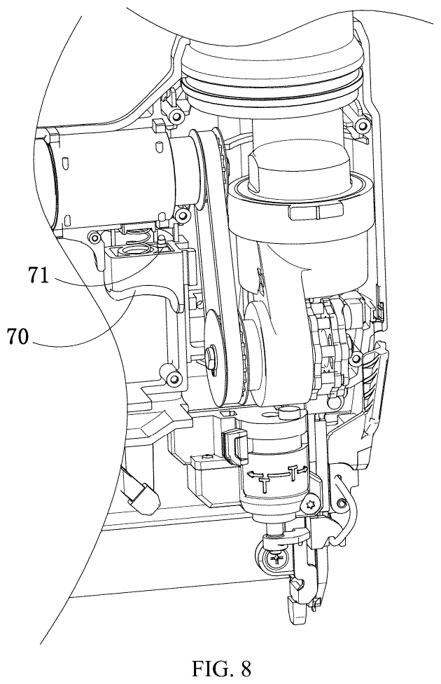

In this embodiment, the nail gun 100 further includes trigger 70. The trigger 70 is disposed below the first housing 11 and at least partially located inside the first housing 11, or inside the second housing 12, or at the connection joint of the first housing 11 and the second housing 12. The trigger 70 is configured to be operated (e.g., pressed) by the user, thereby triggering trigger switch 71 inside the housing assembly 10. In an embodiment, as shown in FIG. 7, the trigger switch 71 is at least partially disposed inside the second housing 12 and located on a left side of the transmission assembly 60, which effectively utilizes the spatial structure inside the second housing 12, and can trigger the trigger switch 71 through an intermediate member or a main body of the trigger 70 when the trigger 70 is operated. In an embodiment, as shown in FIG. 8, the trigger switch 71 is at least partially disposed inside the trigger 70. When the trigger 70 is operated, the trigger switch 71 moves with the trigger 70, such that the trigger switch 71 is triggered by the housing assembly 10 or touched by a rib or other configurations inside the housing assembly 10. By disposing the trigger switch 71 inside the trigger 70, the space of the whole machine is saved to a certain extent. In other embodiments, the trigger switch 71 is at least partially disposed on the connection joint of the first housing 11 and the second housing 12, or at least partially disposed inside the first housing 11. In this embodiment, the trigger switch 71 can be a micro switch or an electronic switch.

In this embodiment, distance D5 between the lowermost end of the trigger 70 and the uppermost end of the magazine assembly 50 is less than or equal to 50 mm, or less than or equal to 45 mm, or less than or equal to 40 mm. Distance D6 between the lowermost end of the trigger 70 and the uppermost end of the reinforced housing 13 is less than or equal to 40 mm, or less than or equal to 35 mm.

In this embodiment, a part except the magazine assembly 50 is defined as main body 1 of the nail gun 100. Then along the vertical direction, distance D8 between an uppermost end of a frontmost end of the magazine assembly 50 and the lowermost end of the grip portion 110 is less than or equal to 60 mm, or less than or equal to 55 mm, or less than or equal to 50 mm.

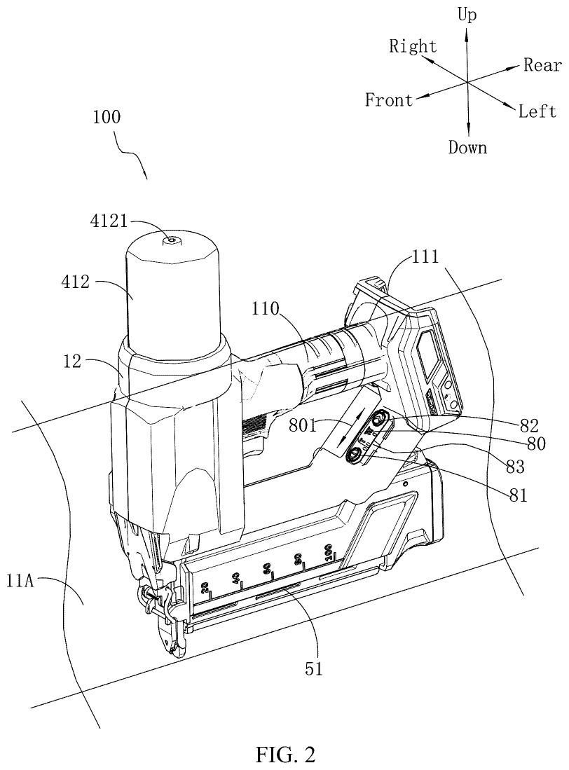

Referring to FIGS. 2 and 5, the nail gun 100 is further provided with mode selection module 80 for the user to operate and select an operating mode of the nail gun 100, such as a continuous nailing mode or a single nailing mode. The mode selection module 80 can be disposed on an upper end of the battery coupling portion 111 formed on the rear end of the first housing 11, or disposed on the reinforced housing 13, or on any other position that is convenient for the user to operate and observe.

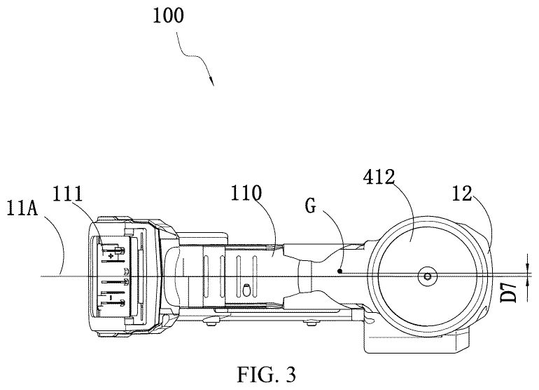

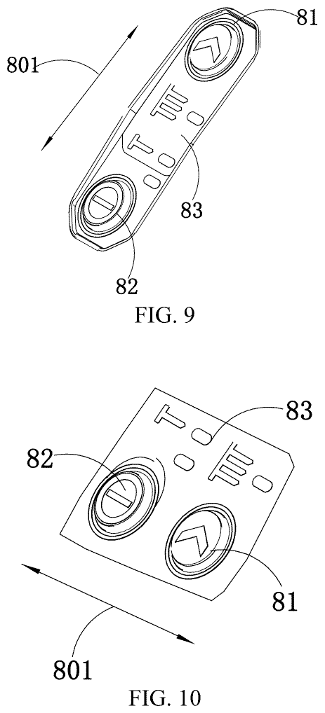

In an embodiment, the mode selection module 80 is provided with mode switch 81, mode option button 82, and mode display interface 83. The mode switch 81 and the mode option button 82 are operated by the user, and the mode display interface 83 can display a current operating mode. To facilitate selection of the operating mode when the nail gun 100 is operated or when the nail gun 100 is held by hand, the mode switch 81 and the mode option button 82 are generally disposed on a same side of the mode selection module 80. A common arrangement includes strip arrangement as shown in FIGS. 9 and 10, or square arrangement, or triangular arrangement in other embodiments. Referring to FIGS. 2 and 3, along the front-rear direction and the vertical direction, the first housing 11 includes central plane 11A, and the central plane 11A can basically serve as a central plane of the nail gun 100 along the front-rear direction and the vertical direction. In this embodiment, as shown in FIG. 2, the mode selection module 80 is disposed on the reinforced housing 13, where arrangement direction 801 of the mode switch 81 and the mode option button 82 is basically parallel to the central plane 11A.

In this embodiment, since the first housing 11 is closer to the magazine assembly 50, or the grip portion is lower, as shown in FIG. 3, distance D7 between center of gravity G of the whole nail gun 100 and the central plane 11A is less than or equal to 5 mm, or less than or equal to 4 mm, or less than or equal to 3 mm, or less than or equal to 2 mm, or less than or equal to 1 mm. In an embodiment, along the vertical direction, the center of gravity G is basically located below the first housing 11. Along the front-rear direction, the center of gravity G is basically located at the position where the trigger 70 is located, or located on the trigger 70. Along the left-right direction, the center of gravity G can be on a left side or a right side of the central plane 11A.

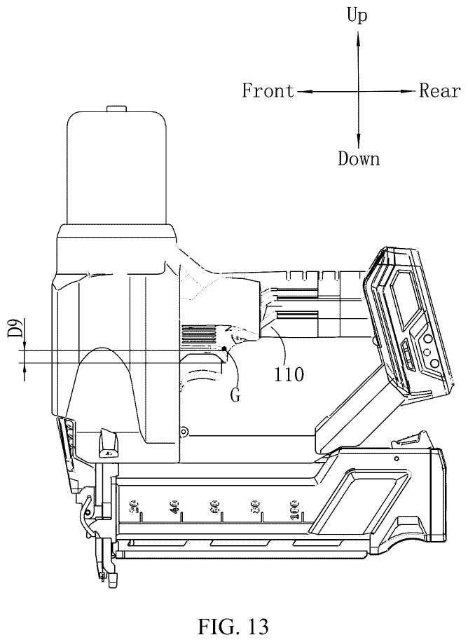

In an embodiment, as shown in FIG. 13, distance D9 between the center of gravity G of the whole nail gun 100 and the lowermost end of the grip portion 110 along the vertical direction is less than or equal to 20 mm, or less than or equal to 15 mm, or less than or equal to 12 mm, or less than or equal to 10 mm, or less than or equal to 8 mm, or less than or equal to 6 mm, or less than or equal to 5 mm, or less than or equal to 2 mm. Thus, when the nail gun 100 is held by hand to drive nails on a vertically placed workpiece such as a vertical wall surface, the center of gravity of the whole nail gun is closer to the hand, thereby saving more effort. It can be understood that the center of gravity G can be located above the lowermost end of the grip portion 110 as shown in FIG. 13, can also be located below the lowermost end of the grip portion 110, or just located at the lowermost end of the grip portion 110.

In this embodiment, when the battery pack is not provided, at least by reducing the second housing 12 outside the outer cylinder 412 and disposing the power assembly 20 inside the first housing 11 to reduce the housing required for separately placing the power assembly 20, the overall weight of the nail gun 100 can be controlled within a range of less than or equal to 2 kg. In an embodiment, the overall weight range of the nail gun 100 is less than or equal to 1.8 kg. In an embodiment, the overall weight range of the nail gun 100 is less than or equal to 1.5 kg. In an embodiment, the overall weight range of the nail gun 100 is less than or equal to 1 kg.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A nail gun, comprising:
a power assembly, comprising at least a motor and a transmission assembly;
a firing assembly, comprising at least a cylinder assembly and a striker assembly;
wherein the cylinder assembly comprises at least an inner cylinder and an outer cylinder; and the inner cylinder is communicated with the outer cylinder; and
the striker assembly is at least partially located inside the inner cylinder; and
a housing assembly, comprising at least a first housing for a user to grip and a second housing for accommodating at least part of the firing assembly;
wherein the power assembly is located inside the first housing; and
a diameter of the motor is less than 38 mm.

2. The nail gun according to claim 1, wherein a distance D1 between the striker and a frontmost end of the second housing along a front-rear direction is less than or equal to 40 mm.

3. The nail gun according to claim 1, wherein the diameter of the motor is less than or equal to 36 mm.

4. The nail gun according to claim 3, wherein the cylinder assembly comprises at least an inner cylinder and an outer cylinder that is at least partially exposed outside; and a first center line of the inner cylinder is substantially parallel to a second center line of the outer cylinder along a vertical direction.

5. The nail gun according to claim 1, wherein an outer surface area of the outer cylinder exposed outside the second housing accounts for at least 20% of a total outer surface area of the outer cylinder.

6. The nail gun according to claim 1, wherein an outer surface of the outer cylinder is at least partially provided with a protective layer.

7. The nail gun according to claim 6, wherein the protective layer comprises at least a polyurea coating.

8. The nail gun according to claim 1, wherein a distance D3 between a lowermost end of a grip portion of the first housing for the user to grip and an uppermost end of a frontmost end of a connection joint between a magazine assembly and a main body along a vertical direction is less than or equal to 60 mm.

9. The nail gun according to claim 1, wherein a distance D7 between a center of gravity of the nail gun and a central plane defined by the first housing along a front-rear direction and a vertical direction is less than or equal to 5 mm.

10. The nail gun according to claim 1, wherein an outer diameter of the transmission assembly is less than or equal to 38 mm.

11. The nail gun according to claim 1, wherein the diameter of the motor is less than or equal to 36 mm.

12. The nail gun according to claim 1, wherein a weight of the nail gun is less than or equal to 2 kg.

13. The nail gun according to claim 1, wherein a distance D9 between a center of gravity of the nail gun and a lowermost end of a grip portion of the first housing along a vertical direction is less than or equal to 20 mm.

14. The nail gun according to claim 1, wherein the nail gun further comprises a drive assembly comprising at least a drive wheel rotatable in a forward direction to drive the striker assembly, wherein the transmission assembly is disposed between the motor and the drive assembly to transmit power to the drive assembly, and the transmission assembly comprises at least a flexible transmission structure.

15. The nail gun according to claim 14, wherein the drive assembly further comprises a one-way clutch structure disposed on a rear end of the drive wheel; and the one-way clutch structure is at least configured to prevent the drive wheel from rotating in a direction opposite to the forward direction.

16. The nail gun according to claim 14, wherein the transmission assembly further comprises a first transmission wheel disposed on an output end of the transmission assembly; and a second transmission wheel disposed on a rear end of the drive wheel; and the flexible transmission structure comprises a first end sleeved on the first transmission wheel and a second end sleeved on the second transmission wheel.

17. The nail gun according to claim 14, wherein during an operation of the nail gun, a surface temperature of the first housing is less than or equal to 55° C.

18. The nail gun according to claim 1, wherein the nail gun further comprises: a heat dissipation assembly; and the heat dissipation assembly is at least partially disposed inside the first housing and/or the second housing, and is configured to dissipate heat for the power assembly.
